(19) United States
(12) Patent Application Publication
(10) Pub. No.: US 2026/0135123 A1
(43) Pub. Date: May 14, 2026

(54) NONAQUEOUS ELECTROLYTIC SOLUTION FOR POWER STORAGE DEVICE, AND POWER STORAGE DEVICE

(71) Applicant: Panasonic Intellectual Property Management Co., Ltd., Kadoma-shi, Osaka (JP)

(72) Inventor: Satoshi Nishitani, OSAKA FU (JP)

(73) Assignee: Panasonic Intellectual Property Management Co., Ltd., Kadoma-shi, Osaka (JP)

(21) Appl. No.: 18/704,622

(22) PCT Filed: Aug. 4, 2022
(86) PCT No.: PCT/JP2022/029898

§ 371 Date: Apr. 25, 2024

(30) Foreign Application Priority Data
Oct. 29, 2021 (JP) 2021-177941

(51) Int. Cl. H01M 6/16; H01G 11/60; H01G 11/62; H01M 4/06; H01M 4/38; H01M 4/50

(52) U.S. Cl. CPC H01M 6/168; H01G 11/60; H01G 11/62; H01M 4/06; H01M 4/382; H01M 4/502; H01M 2300/004

(57) ABSTRACT

A nonaqueous liquid electrolyte includes a solute, a nonaqueous solvent, and an isophorone diisocyanate component. The isophorone diisocyanate component includes a cis-isophorone diisocyanate compound and a trans-isophorone diisocyanate compound. The mass ratio cis/trans of the cis-isophorone diisocyanate compound to the trans-isophorone diisocyanate compound is 35/65 or more and 96/4 or less.

### TECHNICAL FIELD

The present disclosure relates to a nonaqueous liquid electrolyte for a power storage device, and a power storage device.

### BACKGROUND ART

Power storage devices, such as lithium primary batteries, lithium-ion secondary batteries, and lithium secondary batteries (sometimes called lithium-metal secondary batteries and so on) have been more and more often used outdoors. Therefore, power storage devices are required to maintain stable characteristics even when exposed to various environments, such as high temperature environment or extremely low temperature environment below freezing.

Patent Literature 1 proposes a nonaqueous organic liquid electrolyte for a lithium primary battery including manganese dioxide as a positive electrode active material and lithium metal or a lithium alloy as a negative electrode active material, in which an organic compound having a chain structure and belonging to a dicarboxylic acid ester is added as an additive to a base liquid electrolyte composed of an organic solvent and a supporting salt.

Patent Literature 2 proposes a nonaqueous liquid electrolyte including a nonaqueous solvent and an electrolyte salt dissolved therein. The nonaqueous liquid electrolyte contains a complex salt having a partial structure represented by a specific formula.

### CITATION LIST

### Patent Literature

Patent Literature 1: Japanese Laid-Open Patent Publication No. 2016-46027
Patent Literature 2: Japanese Laid-Open Patent Publication No. 2019-71469

### SUMMARY OF INVENTION

### Technical Problem

In a power storage device, the output voltage may drop in low temperature environment in some cases. When the output voltage of the power storage device drops, the equipment equipped with the power storage device may fail to operate properly.

### Solution to Problem

A first aspect of the present disclosure relates to a nonaqueous liquid electrolyte for use in a power storage device, including:
a solute;
a nonaqueous solvent; and
an isophorone diisocyanate component, wherein
the isophorone diisocyanate component includes a cis-isophorone diisocyanate compound and a trans-isophorone diisocyanate compound, and
a mass ratio cis/trans of the cis-isophorone diisocyanate compound to the trans-isophorone diisocyanate compound is 35/65 or more and 96/4 or less.

A second aspect of the present disclosure relates to a power storage device, including:
a pair of electrodes; and a nonaqueous liquid electrolyte, wherein
the nonaqueous liquid electrolyte includes
a solute,
a nonaqueous solvent, and
an isophorone diisocyanate component,
the isophorone diisocyanate component includes a cis-isophorone diisocyanate compound and a trans-isophorone diisocyanate compound, and
a mass ratio cis/trans of the cis-isophorone diisocyanate compound to the trans-isophorone diisocyanate compound is 35/65 or more and 96/4 or less.

### Advantageous Effects of Invention

It is possible to provide a nonaqueous liquid electrolyte for a power storage device and a power storage device that can ensure high output voltage in low temperature environment.

### BRIEF DESCRIPTION OF DRAWING

FIG. 1 A partial cross-sectional front view of a power storage device according to an embodiment of the present disclosure.

### DESCRIPTION OF EMBODIMENTS

While the novel features of the invention are set forth particularly in the appended claims, the invention, both as to organization and content, will be better understood and appreciated, along with other objects and features thereof, from the following detailed description taken in conjunction with the drawings.

The output of a power storage device is greatly influenced by the progress of the battery reactions at the interfaces between the electrodes and the nonaqueous liquid electrolyte. Especially in low temperature environment, the diffusivity of ions in the nonaqueous liquid electrolyte decreases, making it difficult for the battery reactions to proceed at the interfaces between the electrodes and the nonaqueous liquid electrolyte. In low temperature environment, therefore, the output characteristics of the power storage device tend to deteriorate, causing a significant drop in output voltage. When the drop in output voltage is significant, it may fail to secure sufficient voltage to operate an equipment equipped with the power storage device. The power storage device includes, for example, batteries and capacitors that utilize nonaqueous liquid electrolyte. The power storage device may be, for example, a nonaqueous liquid electrolyte battery or a capacitor that uses lithium ions as charge carriers (hereinafter sometimes, carrier ions). Examples of such power storage devices include lithium primary batteries, lithium-ion secondary batteries, lithium secondary batteries, and lithium-ion capacitors.

In recent years, there has been an accelerated trend toward ICT (Information and Communication Technology), including DX (Digital Transformation) etc. An example of equipment that has been getting popularity ahead in ICT is a smart meter. The smart meter is an equipment that transmits data regarding the consumed quantity of gas or electricity. The equipment utilized for such purposes is required to continue operating for a long time without maintenance. For example, a lithium primary battery, because of its high energy density and little self-discharge, is suitable for long term use.

The equipment utilized for the purposes as above is often used outdoors, and often exposed to various environments, such as high temperature environment and low temperature environment. Therefore, power storage devices to be equipped in such equipment, such as lithium primary batteries, are required to have a stable output voltage even when exposed to harsh environments, such as high temperature or low temperature.
In view of the above, (1) the nonaqueous liquid electrolyte according to the first aspect of the present disclosure includes a solute, a nonaqueous solvent, and an isophorone diisocyanate component. The isophorone diisocyanate component includes a cis-isophorone diisocyanate compound and a trans-isophorone diisocyanate compound. The mass ratio cis/trans of the cis-isophorone diisocyanate compound to the trans-isophorone diisocyanate compound is 35/65 or more and 96/4 or less. Such a nonaqueous liquid electrolyte is used in a power storage device. In the present specification, the “isophorone diisocyanate component” and the “isophorone diisocyanate compound” are sometimes referred to as an “IPDI component” and an “IPDI compound,” respectively. The cis-isophorone diisocyanate compound and the trans-isophorone diisocyanate compound are sometimes referred to as a cis-body and a trans-body, respectively.
(2) The present disclosure also encompasses a power storage device including a positive electrode, a negative electrode, and a nonaqueous liquid electrolyte. The nonaqueous liquid electrolyte includes a solute, a nonaqueous solvent, and an IPDI component. The IPDI component includes a cis-body and a trans-body. The cis/trans ratio, which is the mass ratio of the cis-body to the trans-body, is 35/65 or more and 96/4 or less.

The cis-body and the trans-body can be respectively represented by the following formulas.

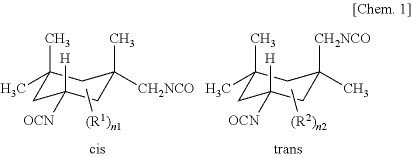

(In the formula, R¹ and R² are each independently a substituent, n1 represents is the number of the substituents R¹, and n2 represents the number of the substituents R².)

When a nonaqueous liquid electrolyte containing an IPDI component is used in a power storage device, a film derived from the IPDI component is formed on the electrode. As shown in the above formulas, in the cis-body, the isocyanate group —NCO and the isocyanato methyl group —CH₂—NCO bonded to the cyclohexane ring are both located at equatorial position in the lateral direction, and two isocyanate groups are directed in the same direction with respect to the electrode surface and react with each other so as to crosslink the electrode surface, so that a protection effect in the planar direction is likely to be obtained. The cis-body, which is therefore easily oriented on the electrode and forms a relatively dense film, is highly effective in protecting the electrode and likely to suppress side reactions between the electrodes and the nonaqueous solvent etc. On the other hand, in the trans-body, the isocyanate group bonded to the cyclohexane ring is located at equatorial position, whereas the isocyanato methyl group is located at axial position. Therefore, when the nonaqueous liquid electrolyte moderately contains the trans-body in addition to the cis-body, the film formed on the electrode tends to grow three-dimensionally and is suppressed from being excessively dense. It is considered therefore that, while the increase in resistance due to the protective film is suppressed, the protection effect of the electrode can be further improved. When the cis/trans ratio is 35/65 or more and 96/4 or less, it is presumed that a film with excellent film quality is formed on the electrode, which can ensure the effect of protecting the electrode surface while suppressing the resistance of the film low, and can ensure high ion conductivity. As a result, for example, even in low temperature environment of −20° C. or less (e.g., −30° C.), high output voltage of the power storage device can be ensured. When the cis/trans ratio is less than 35/65 and when it exceeds 96/4, the output voltage in low temperature environment drops, as compared to when the cis/trans ratio is 35/65 or more and 96/4 or less. This is presumably because when the cis/trans ratio is less than 35/65, since the proportion of the trans-body is too large, the film formed on the electrode derived from the IPDI component becomes coarse, and side reactions between the electrodes and the nonaqueous solvent etc. tend to occur. On the other hand, when the cis/trans ratio exceeds 96/4, since the proportion of the trans-body is too small, the film becomes too dense, resulting in the resistance which is too high.

In general, when a power storage device is exposed to high temperature environment, the reaction between the nonaqueous liquid electrolyte and the electrodes proceeds vigorously, which facilitates the growth of a film on the electrode, so that the resistance of the film tend to be high. When the power storage device is used in low temperature environment after the film with high resistance has been formed on the electrode in high temperature environment, the output voltage will drop significantly. Since the nonaqueous liquid electrolyte of the present disclosure has a cis/trans ratio of 35/65 or more and 96/4 or less, the resistance of the film formed when the power storage device is exposed to high temperature environment (e.g., during storage at high temperature) can be suppressed low, and the high ion conductivity of the film is likely to be ensured. Thus, it is possible to suppress the drop in output voltage of the power storage device when the power storage device is used in low temperature environment after exposed to high temperature environment (e.g., after storage at high temperature).
(3) In the nonaqueous liquid electrolyte of the above (1) or (2), the concentration of the isophorone diisocyanate component may be 15 mass % or less.
(4) In any one of the above (1) to (3), the solute may include a lithium salt. (5) In any one of the above (1) to (4), the power storage device may be a lithium primary battery including a pair of electrodes. One of the pair of electrodes may include at least one of metal lithium and a lithium alloy, and the other electrode may include a positive electrode mixture containing manganese dioxide.
(6) In the above (2), one of the pair of electrodes may be capable of electrochemically dissolving or releasing lithium ions, and the other electrode may be capable of electrochemically depositing or absorbing lithium ions, and the nonaqueous liquid electrolyte may include a lithium salt.
(7) In the above (6), the one electrode may contain at least one selected from the group consisting of lithium element, silicon element, and a carbonaceous material, and the other electrode may contain at least one element selected from the group consisting of manganese, nickel, and cobalt.

In the following, the nonaqueous liquid electrolyte and the power storage device of the present disclosure, including the above (1) to (7), will be more specifically described. At least two of the above (1) to (7) may be combined, as long as no technical contradiction arises. Furthermore, at least one of the above (1) to (7) may be combined with at least one of the elements described below, as long as no technical contradiction arises.

### [Nonaqueous Liquid Electrolyte]

### (IPDI Component)

The nonaqueous liquid electrolyte contains, as the IPDI component, the cis- and the trans-body of the IPDI compound represented by the above formula. In the IPDI compound, since three methyl groups, an isocyanate group, and an isocyanato methyl group are bonded to the cyclohexane ring, ring inversion of the cyclohexane ring hardly occurs. Therefore, as shown in the above formula, in either form of the cis-body and the trans-body, the cyclohexane ring basically takes an energetically stable chair-shaped structure.

Examples of the substituent represented by R¹ or R² include an alkyl group and an alkoxy group. The number of carbon atoms in the substituent is, for example, 1 to 3, and may be 1 or 2. Each of n1 and n2 can take an integer of 0 to 6, may be an integer of 0 to 3, and may be an integer of 0 to 2. R¹ and R² may be the same or different. When the cis-body has a plurality of R¹s, at least two of the R¹s may be the same or all may be different. When the trans-body has a plurality of R²s, at least two of the R²s may be the same or all may be different.

The IPDI component may include one type of IPDI compound (that is, may include the cis- and the trans-body of the same IPDI compound). Further, the IPDI component may include two or more types of IPDI compounds differing in the substituent or the number of the substituents. For example, the IPDI component may include one or more types of cis-bodies. The IPDI component may include one or more types of trans-bodies. In particular, the IPDI component preferably includes, among IPDI compounds, the cis- and the trans-body of an isophorone diisocyanate (IPDI), where n1=0 and n2=0. Such a compound is easily available, and can be used to ensure higher output voltage in low temperature environment.

The cis/trans ratio, which is a mass ratio of the cis-body to the trans-body, is 35/65 or more, and may be 39/91 or more. When the cis/trans ratio is within this range, high output voltage can be ensured in low temperature environment. Form the viewpoint that higher output voltage in low temperature environment is likely to be obtained, the cis/trans ratio is preferably 60/40 or more or 65/35 or more, and may be 68/32 or more. When the cis/trans ratio is in such a range, it is also possible to ensure higher output voltage in low temperature environment after storage at high temperature. The cis/trans ratio is 96/4 or less, and may be 95/5 or less. When the cis/trans ratio is in such a range, high output voltage in low temperature environment can be ensured. Form the viewpoint that higher output voltage in low temperature environment is likely to be obtained, the cis/trans ratio is preferably 85/15 or less or 83/17 or less. When the cis/trans ratio is in such a range, it is also possible to ensure higher output voltage in low temperature environment after storage at high temperature. These lower and upper limits can be combined in any combination. The cis/trans ratio may be, for example, 35/65 or more and 96/4 or less, 60/40 or more and 96/4 or less, or 65/35 or more and 96/4 or less. Such a cis/trans ratio is a value (in other words, an initial value) in the nonaqueous liquid electrolyte used for assembling a power storage device. In a power storage device, since the IPDI component is consumed for film formation, the concentration of the IPDI component in the nonaqueous liquid electrolyte changes, but as for the cis/trans ratio, not much change from the initial value is observed. Therefore, the cis/trans ratio may be in the above range in the nonaqueous liquid electrolyte included in the power storage device. When the IPDI component contains a plurality types of cis-bodies or a plurality types of trans-bodies, the cis/trans ratio is determined from the total amount of the cis-bodies and the total amount of the trans-bodies.

The concentration of the IPDI component in the nonaqueous liquid electrolyte is, for example, 15 mass % or less. Form the viewpoint that higher output voltage in low temperature environment is likely to be obtained, the concentration of the IPDI component is preferably 12 mass % or less, and more preferably 10 mass % or less. When the concentration of the IPDI component is in such a range, higher output voltage in low temperature environment after storage at high temperature is also likely to be ensured. The concentration of the IPDI component in the nonaqueous liquid electrolyte may be 0.1 mass % or more, and may be 0.2 mass % or more. Form the viewpoint that higher output voltage in low temperature environment is likely to be obtained, the concentration of the IPDI component in the nonaqueous liquid electrolyte is preferably 0.5 mass % or more or 1 mass % or more, may be 1.5 mass % or more or 2 mass % or more, and may be 3 mass % or more. These upper and lower limits can be combined in any combination. The concentration of the IPDI component in the nonaqueous liquid electrolyte may be 0.1 mass % or more (or 0.2 mass % or more) and 15 mass % or less, may be 0.5 mass % or more and 15 mass % or less (or 12 mass % or less), and may be 1.5 mass % or more (or 2 mass % or more) and 12 mass % or less). Such a concentration of the IPDI component is a value (in other words, an initial value) in the nonaqueous liquid electrolyte used for assembling a power storage device. The concentration of the IPDI component determined with respect to the nonaqueous liquid electrolyte sampled from the power storage device may be in the above range. In the power storage device, since the IPDI component is consumed for film formation, the concentration of the IPDI component in the nonaqueous liquid electrolyte changes, for example, during storage or with use. Therefore, when analyzing with respect to a nonaqueous liquid electrolyte sampled from the power storage device, it suffices as long as the IPDI component remains in the nonaqueous liquid electrolyte at a concentration equal to or higher than the detection limit. Accordingly, the upper limit of the concentration of the IPDI component may be in the above range, and the lower limit thereof may be equal to or higher than the detection limit.

### (Nonaqueous Solvent)

Examples of the nonaqueous solvent include ethers, esters (carboxylic acid esters, etc.), and carbonic acid esters. These may be chain compounds or cyclic compounds. Examples of chain ethers include dimethyl ether and 1,2-dimethoxyethane (DME). Examples of cyclic ethers include 1,3-dioxolane, 4-methyl-1,3-dioxolane, tetrahydrofuran, and 2-methyltetrahydrofuran. Examples of chain carboxylic acid esters include formate esters (ethyl formate, etc.), acetate esters (methyl acetate, ethyl acetate, propyl acetate, etc.), and propionate esters (methyl propionate, ethyl propionate, methyl fluoropropionate, etc.). Examples of the cyclic carboxylic acid esters include γ-butyrolactone and γ-valerolactone. Examples of chain carbonic acid esters include diethyl carbonate, ethyl methyl carbonate, and dimethyl carbonate. Examples of the cyclic carbonic acid esters include propylene carbonate (PC) and ethylene carbonate (EC). The nonaqueous liquid electrolyte may contain the nonaqueous solvent singly, or in combination of two or more kinds.

From the viewpoint of improving the discharge characteristics of the power storage device, it is preferable that the nonaqueous solvent includes a cyclic carbonic acid ester which has a high boiling point, and a chain ether which exhibits low viscosity at low temperature. The cyclic carbonic acid ester preferably includes at least one selected from the group consisting of PC and EC. The chain ether preferably includes, for example, DME. (Solute)

Examples of the solute include salts of cations (carrier ions) which act as charge carriers in the nonaqueous liquid electrolyte and anions which are counter ions of the cations. For example, in a power storage device (lithium primary battery, lithium-ion secondary battery, lithium secondary battery, lithium-ion capacitor, etc.) in which lithium ions act as carrier ions, a lithium salt is used as the solute. The solute of the nonaqueous liquid electrolyte may include a lithium salt.

Examples of the lithium salt include LiClO₄, LiBF₄, LiPF₆, LiR^{a}SO₃ (LiCF₃SO₃, etc.), LiFSO₃, imide salts (LiN(SO₂R^{b})(SO₂R^{c}), LiN(FSO₂)₂, etc.), LiC(SO₂R_{d})(SO₂R^{e})(SO₂R^{f}), LiPO₂F₂, and oxalate complex salts. R^{a} to R^{f} are each independently a fluorinated alkyl group. The number of carbon atoms in the fluorinated alkyl group is, for example, 1 to 12, and may be 1 to 6 or 1 to 4. R^{b} and R^{e} may be the same (e.g., LiN(CF₃SO₂)₂, LiN(C₂F₅SO₂)₂) or different (e.g., LiN(CF₃SO₂)(C₄F₉SO₂)). At least two of R^{d} to R^{f} may be the same, or all may be different. Examples of the oxalate complex salt include lithium bisoxalate borate (LiB(C₂O₄)₂), LiBF₂(C₂O₄), LiPF₄(C₂O₄), and LiPF₂(C₂O₄)₂. Furthermore, as the lithium salt, LiAlCl₄, LiAlF₄, LiAsF₆, LiSbF₆, LiTaF₆, LiNbF₆, LiSiF₆, LiCH₃BF₃, LiCN, LiSCN, LiCF₃CO₂, LiB₁₀Cl₁₀, LiNO₃, LiNO₂, lithium lower aliphatic carboxylate, lithium halide (LiCl, etc.), and borates, such as lithium bis(1,2-benzenediolate(2-)—O,O′)borate may also be used. The nonaqueous liquid electrolyte may contain the lithium salt singly, or in combination of two or more kinds. The lithium salt is selected depending on, for example, the type of the power storage device, the components contained in the electrode, and the like. (Others)

The concentration of the solute (or carrier ions) in the nonaqueous liquid electrolyte may be, for example, 0.1 mol/L or more and 3.5 mol/L or less. The concentration of the solute is selected depending on, for example, the type, the capacity or capacitance, etc. of the power storage device. For example, in a lithium primary battery, the concentration of the solute may be in the above range, and may be 0.2 mol/L or more and 2.0 mol/L or less.

The nonaqueous liquid electrolyte may contain, as necessary, an additive other than the IPDI component. Examples of the additive include propane sultone, propene sultone, ethylene sulfate, tristrimethylsilyl phosphite, tristrimethylsilyl phosphate, vinylene carbonate, fluoroethylene carbonate, and vinyl ethylene carbonate. The total concentration of such additives contained in the nonaqueous liquid electrolyte is, for example, 5 mol/L or less. The total concentration of the additives may be 0.003 mol/L or more. The nonaqueous liquid electrolyte may contain at least one of a cyclic imide (phthalimide, etc.) and a phthalic acid ester (dimethyl phthalate, etc.), but when not containing such a component or when containing it, the concentration of these components (e.g., total concentration) may be less than 0.1 mass %.

Depending on the type of the power storage device, the nonaqueous liquid electrolyte may be, as necessary, a gel electrolyte with no fluidity which is a composite of a gelling agent or matrix material and a nonaqueous liquid electrolyte.

### [Power Storage Device]

The power storage device includes a pair of electrodes and a nonaqueous liquid electrolyte. The above nonaqueous liquid electrolyte is used as the nonaqueous liquid electrolyte. Among the configurations of the components of the power storage device, configurations other than that of the nonaqueous liquid electrolyte will be more specifically described below.

One of the pair of electrodes is capable of electrochemically dissolving or releasing carrier ions (lithium ions, etc.), and the other is capable of electrochemically depositing or absorbing carrier ions (lithium ions, etc.). In the present specification, the case of being capable of absorbing carrier ions encompasses also the case of being capable of adsorbing carrier ions. In a secondary battery or a capacitor, each electrode is capable of electrochemically dissolving and depositing carrier ions, or electrochemically releasing and absorbing (or desorbing and adsorbing) carrier ions. Each electrode may contain an active material having such a function.

The cis- and the trans-body of the IPDI compound has a tendency to act on the active material or the conductive agent contained in the electrode, to form a film. Especially when the electrode contains at least one selected from the group consisting of lithium (Li) element, silicon (Si) element, and a carbonaceous material, the cis- and the trans-body of the IPDI compound contained in the nonaqueous liquid electrolyte is likely to act on the Li element, Si element, or carbonaceous material in the electrode, to form a film with excellent film quality as described above. When the electrode contains an element of a polyvalent metal with an oxidation number of 2 or more (at least one selected from the group consisting of manganese (Mn), nickel (Ni), and cobalt (Co), etc.), the isocyanate group or the isocyanato methyl group acts on these elements contained in the electrode, so that the protection effect is likely to be obtained. Therefore, the effect of suppressing the drop in output voltage in low temperature environment when using the above-mentioned nonaqueous liquid electrolyte can be remarkably obtained especially in: a power storage device using an electrode containing at least one element selected from the group consisting of Li element, Si element, and a carbonaceous material; a power storage device using an electrode containing at least one element selected from the group consisting of Mn, Ni, and Co; and a power storage device in which one of the pair of electrodes contains at least one selected from the group consisting of Li element, Si element, and a carbonaceous material, and the other electrode contains at least one selected from the group consisting of Mn, Ni, and Co. Examples of the carbonaceous material include a graphitic material, carbon black, and activated carbon. Examples of the power storage device using such electrodes include a lithium primary battery, a lithium-ion secondary battery, a lithium secondary battery, and a lithium-ion capacitor. The nonaqueous liquid electrolyte of the present disclosure is particularly suitable for use in these power storage devices. Note that, in a lithium secondary battery, although the negative electrode contains only a current collector in the initial stage in some cases, the cis- and the trans-body of the IPDI compound acts on the metal lithium deposited on the current collector during charging, to form a film with excellent film quality.

### (One of Electrodes)

In the power storage device, one of the pair of electrodes may be, for example, a negative electrode. The other electrode may be, for example, a positive electrode. The configuration of each electrode is determined depending on, for example, the type of the power storage device.

### (Negative Electrode)

In a lithium primary battery, the negative electrode contains metal lithium or a lithium alloy, and may contain both metal lithium and a lithium metal. A composite of metal lithium and a lithium alloy may also be used.

The lithium alloy may contain an element, such as aluminum, tin, silicon, magnesium, indium, lead, and zinc, in addition to lithium. Examples of the lithium alloy include Li—Al alloy, Li—Sn alloy, Li—Ni—Si alloy, Li—Pb alloy, Li—Mg alloy, Li—Zn alloy, Li—In alloy, and Li—Al—Mg alloy. From the viewpoint of ensuring the discharge capacity and stabilizing the internal resistance, the content of the metal element(s) other than lithium in the lithium alloy may be 0.05 mass % or more and 15 mass % or less.

The metal lithium, the lithium alloy, or the composite thereof is molded into a desired shape and thickness, depending on the shape, the dimensions, the standard performance, etc. of the lithium primary battery.

In the case of a coin-shaped battery, the negative electrode may be formed by punching a hoop-like metal lithium, lithium alloy, or the like into a disk shape. In the case of a cylindrical battery, the negative electrode may be a sheet of metal lithium, lithium alloy, or the like. The sheet is obtained, for example, by extrusion molding.

In each of the lithium-ion secondary battery and the lithium-ion capacitor, the negative electrode includes a negative electrode active material capable of absorbing and releasing lithium ions, or capable of dissolving or depositing lithium ions. The negative electrode may include a negative electrode current collector holding a negative electrode active material. The negative electrode may include, for example, a negative electrode mixture containing a negative electrode active material and a negative electrode current collector holding the negative electrode mixture. Examples of the negative electrode active material include lithium metal, a lithium alloy, a carbonaceous material (graphitic material, soft carbon, hard carbon, amorphous carbon, etc.), a Si-containing material (Si simple substance, Si alloy, Si compound such as oxide, nitride and carbide, etc.), and a Sn-containing material (Sn simple substance, Sn alloy, Sn compound, etc.). The negative electrode may contain the negative electrode active material singly, or in combination of two or more kinds. From the viewpoint that a film with excellent film quality derived from the IPDI component is likely to be formed, a negative electrode including a negative electrode active material containing at least one selected from the group consisting of Li element, Si element (Si-containing material etc.), and a carbonaceous material may be used. The negative electrode mixture contains, in addition to the negative electrode active material, a binder (fluorocarbon resin, olefin resin, polyamide resin, polyimide resin, acrylic resin, rubbery polymer, etc.), a thickener (carboxymethylcellulose or its salt, etc.), a conductive agent (carbon black, carbon fiber, etc.), and the like can be used. The negative electrode can be formed by, for example, applying a paste containing materials of the negative electrode mixture onto the negative electrode current collector. The negative electrode may be formed by allowing a negative electrode active material to deposit on a negative electrode current collector.

In a lithium secondary battery, the negative electrode includes a current collector. As the current collector, a conductive sheet made of a conductive material other than lithium metal and lithium alloys may be used. On a surface of the current collector, at least one of a negative electrode mixture layer and a layer containing lithium (sometimes referred to as a foundation layer) may be formed. The negative electrode mixture layer is formed, for example, by applying a paste containing a negative electrode active material onto at least part of the surface of the negative electrode current collector. The foundation layer is a layer provided in advance and containing metal lithium or a lithium alloy. The lithium alloy may contain, in addition to lithium, for example, at least one element selected from the group consisting of aluminum, magnesium, indium, and zinc. From the viewpoint that a film with excellent film quality derived from the IPDI component is likely to be formed, a negative electrode including a foundation layer containing lithium may be used.

### (Positive Electrode)

The positive electrode includes a positive electrode mixture. The positive electrode may include a positive electrode mixture and a positive electrode current collector holding the positive electrode mixture. The positive electrode mixture contains a positive electrode active material. The positive electrode mixture may further contain a binder, a conductive agent, and the like.

In a lithium primary battery, the positive electrode active material includes, for example, manganese dioxide. A positive electrode containing manganese dioxide as a positive electrode active material develops a relatively high voltage and is excellent in pulse discharge characteristics. Manganese dioxide may be in a mixed crystal state including a plurality of types of crystal states. The positive electrode may contain a manganese oxide other than manganese dioxide. Examples of the manganese oxide other than manganese dioxide include MnO, Mn₃O₄, Mn₂O₃, and Mn₂O₇. It suffices as long as the major component (e.g., 50 mass % or more) of the manganese oxide contained in the positive electrode is manganese dioxide.

The manganese dioxide contained in the positive electrode may be partially doped with lithium. When the amount of lithium doped is small, high capacity can be ensured. Manganese dioxide and a manganese dioxide doped with a small amount of lithium can be expressed by LiₓMnO₂, where 0≤x≤0.05. Manganese dioxide also encompasses a manganese oxide expressed by such a formula. It suffices as long as the average composition of the whole manganese oxide contained in the positive electrode is LiₓMnO₂, where 0≤x≤0.05. The ratio x of Li is 0.05 or less in the initial stage of discharge of the lithium primary battery. The ratio λ of Li increases as the discharge of the lithium primary battery proceeds. The oxidation number of the manganese contained in the manganese dioxide is theoretically 4, but as for the average oxidation number of manganese, somewhat increase or decrease from 4 is permissible.

The positive electrode can include, in addition to manganese dioxide, another positive active material used in lithium primary batteries. Examples of the other positive electrode active material include fluorinated graphite. The proportion of the manganese dioxide in the whole positive electrode active material is preferably 90 mass % or more.

Examples of the binder include fluorocarbon resin, rubber particles, and acrylic resin.

Examples of the conductive agent include a conductive carbonaceous material. Examples of the conductive carbonaceous material include natural graphite, artificial graphite, carbon black, and carbon fibers.

The material for the positive electrode current collector may be, for example, stainless steel, aluminum, titanium, and the like.

In the case of a coin-shaped battery, the positive electrode may be constituted by attaching a ring-shaped positive electrode current collector with an L-shaped cross section to a positive electrode mixture pellet, or the positive electrode may be constituted only of a positive electrode mixture pellet. The positive electrode mixture pellet can be obtained by, for example, compression molding a wet positive-electrode mixture prepared by adding an appropriate amount of water to a positive electrode active material and additives, followed by drying.

In the case of a cylindrical battery, a positive electrode including a sheet of positive electrode current collector and a positive electrode mixture layer held on the positive electrode current collector can be used. As the sheet of positive electrode current collector, metal foil may be used, or a current collector with pores may be used. Examples of the current collector with pores include expanded metal, net, and punched metal. The positive electrode mixture layer can be obtained by, for example, applying the aforementioned wet positive-electrode mixture onto a surface of a sheet of positive electrode current collector or packing it into the positive electrode current collector, applying a pressure thereto in the thickness direction, followed by drying.

In a lithium-ion secondary battery, as the positive electrode active material, for example, a composite oxide containing lithium and a transition metal can be used. Examples of the transition metal include Ni, Co, and Mn. Examples of the composite oxide include LiₐCoO₂, LiₐNiO₂, LiₐMnO₂, LiₐCO_{b1}Ni_{1-b1}O₂, LiₐCO_{b1}M_{1-b1}O_{c1}, LiₐNi_{1-b1}M_{b1}O_{c1}, LiₐMn₂O₄, and LiₐMn_{2-b1}M_{b1}O₄. Here, a=0 to 1.2, b1=0 to 0.9, and c1=2.0 to 2.3. Mis at least one selected from the group consisting of Na, Mg, Sc, Y, Mn, Fe, Co, Ni, Cu, Zn, Al, Cr, Pb, Sb, and B. Note that the value a indicating the molar ratio of lithium increases or decreases during charging and discharging. The composite oxide may be LiₐNi_{b2}M_{1-b2}O₂, where 0<a≤1.2, 0.3≤b2≤1, and M is at least one selected from the group consisting of Mn, Co, and Al. The positive electrode active material may be included singly, or in combination of two or more kinds. From the viewpoint that a film with excellent film quality derived from the IPDI component is likely to be formed, a positive electrode including a positive electrode active material containing a polyvalent metal (esp., at least one selected from the group consisting of Mn, Ni, and Co) may be used.

In a lithium secondary battery, as the positive electrode active material, for example, a lithium-containing transition metal oxide, a transition metal fluoride, a polyanion, a fluorinated polyanion, and a transition metal sulfide can be used. Examples of the transition metal element contained in the lithium-containing transition metal oxide include at least one selected from the group consisting of Sc, Ti, V, Cr, Mn, Fe, Co, Ni, Cu, Y, Zr, and W. From the viewpoint that a film with excellent film quality derived from the IPDI component is likely to be formed, the lithium-containing transition metal oxide may contain, as the transition metal element, at least one selected from the group consisting of Mn, Ni, and Co. The lithium-containing transition metal oxide may contain a typical metal (e.g., at least one selected from the group consisting of Mg, Al, Ca, Zn, Ga, Ge, Sn, Sb, Pb, Bi, etc. (esp., at least Al)).

In a lithium-ion capacitor, the positive electrode includes, for example, a carbonaceous material serving as an active material, as an essential component, and may also include a binder, a conductive agent, and the like, as optional components. As the carbonaceous material, for example, activated carbon, carbon nanotubes, graphite, graphene, and the like can be used.

Examples of the binder and the conductive agent used in the positive electrode of each of the lithium-ion secondary battery, lithium secondary battery, and lithium-ion capacitor include those exemplified for the lithium primary battery. In the case of these power storage devices, too, the positive electrode can be prepared similarly to in the case of the lithium primary battery. For example, the positive electrode is produced by applying a paste or slurry containing the components of positive electrode mixture onto a surface of a positive electrode current collector, and then drying and compressing the applied film. (Separator)

The power storage device may include a separator interposed between a pair of electrodes. As the separator, for example, a nonwoven fabric, a microporous film, or a laminate thereof, and the like can be used. The thickness of the separator is, for example, 5 μm or more and 100 μm or less.

The nonwoven fabric is constituted of fibers containing, for example, polypropylene, polyphenylene sulfide, polybutylene terephthalate, and the like. The microporous film includes, for example, a polyolefin resin, such as polyethylene, polypropylene, and ethylene-propylene copolymer. (Others)

The structure of the power storage device is not limited to a particular one. The structure may be selected depending on the type of the power storage device. For example, the power storage device may be coin-shaped, which is configured by laminating a disc-shaped positive electrode and a disc-shaped negative electrode with a separator interposed therebetween. The power storage device may be cylindrically shaped, which includes an electrode group configured by spirally winding a belt-like positive electrode and a belt-like negative electrode with a separator interposed therebetween.

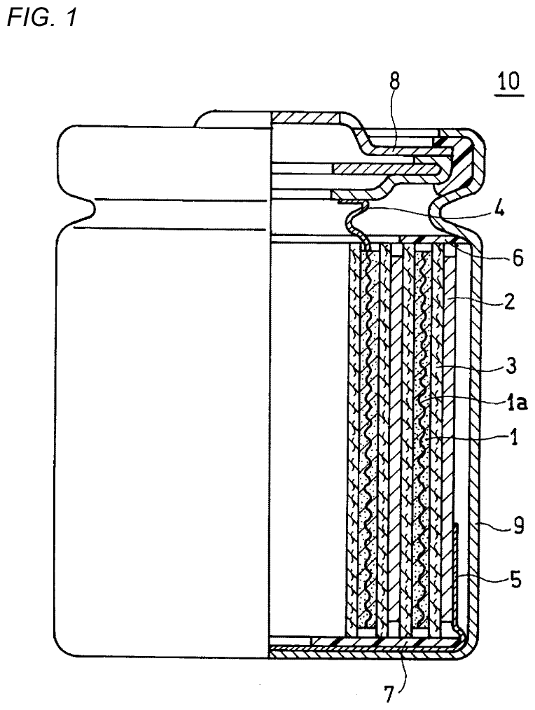

FIG. 1 is a partial cross-sectional front view of a cylindrical power storage device according to one embodiment. In a power storage device 10, an electrode group formed by winding a positive electrode 1 and a negative electrode 2, with a separator 3 interposed therebetween, is housed in a battery case 9 together with a nonaqueous liquid electrolyte (not shown). A sealing plate 8 is attached to the opening of the battery case 9. A positive electrode lead 4 connected to a current collector 1a of the positive electrode 1 is connected to the sealing plate 8. A negative electrode lead 5 connected to the negative electrode 2 is connected to the battery case 9. An upper insulating plate 6 and a lower insulating plate 7 are disposed on the top and the bottom of the electrode group, respectively.

### EXAMPLES

In the following, the present invention will be specifically described based on Examples and Comparative Examples. The present invention, however, is not limited to the following Examples.

### Examples 1 to 8 and Comparative Examples 1 to 3

Lithium primary batteries each as a power storage device were produced by the following procedure.

### (Production of Positive Electrode)

As a positive electrode, 5 parts by mass of Ketjen black serving as a conductive agent, 5 parts by mass of polytetrafluoroethylene serving as a binder, and an appropriate amount of pure water were added to 100 parts by mass of electrolytic manganese dioxide, and kneaded together, to prepare a positive electrode mixture in a wet state.

Next, the positive electrode mixture was packed into a positive electrode current collector made of expanded metal made of stainless steel (SUS444) with a thickness of 0.1 mm, to prepare a positive electrode precursor. Then, the positive electrode precursor was dried, rolled using a roll press until the thickness reached 0.4 mm, and cut into a sheet of 3.5 cm long and 20 cm wide, to obtain a positive electrode. Subsequently, a portion of the packed positive electrode mixture was peeled off, and a lead made of SUS444 was resistance welded to the exposed portion of the positive electrode current collector.

### (Production of Negative Electrode)

A metal lithium foil having a thickness of 300 μm was cut into a size of 3.7 cm long and 22 cm wide, to obtain a negative electrode. A lead made of nickel was connected to the negative electrode at a predetermined point, by welding.

### (Fabrication of Electrode Group)

The positive electrode and the negative electrode were wound so as to face each other with a separator interposed therebetween, to form an electrode group. The separator used here was a microporous polypropylene film having a thickness of 25 μm.

### (Preparation of Nonaqueous Liquid Electrolyte)

PC, EC, and DME were mixed in a volume ratio of 3:2:5. In the mixed solvent, LiCF₃SO₃ was dissolved at a concentration of 0.5 mol/L, and an IPDI having a cis/trans ratio as shown in Table 1 was dissolved at a concentration as shown in Table 1, to prepare a nonaqueous liquid electrolyte. In Comparative Example 1, no IPDI component was used.

### (Assembling of Power Storage Device)

The electrode group was housed in a cylindrical battery case serving as a negative electrode terminal. The battery case used here was an iron case (outer diameter 17 mm, height 45.5 mm). Next, after the nonaqueous liquid electrolyte was injected into the battery case, the opening of the battery case was closed with a metal sealing body serving as a positive electrode terminal. The other end of the positive electrode lead was connected to the sealing body, and the other end of the negative electrode lead was connected to the inner bottom surface of the battery case. In this way, power storage devices (lithium primary batteries) for test use were fabricated. The design capacity of the lithium primary batteries was 2000 mAh.

### (Evaluation)

The power storage devices immediately after assembling were subjected to, at 25° C., a constant-current discharge at 2.5 mA until the depth of discharge (DOD) reached 75%. The batteries after this discharge were placed in a −30° C. environment. Then, the batteries were discharged at a pulse current of 200 mA for 1 second, to measure a battery voltage (open-circuit voltage) V during pulse discharge. The lowest open-circuit voltage during current application for 1 second was taken as the initial output voltage in low temperature environment.

The power storage devices immediately after assembling were stored at 70° C. for 120 days. Using the power storage devices after storage at high temperature, the battery voltage (open-circuit voltage) V after pulse discharge was measured in low temperature environment in a similar manner to that for measuring the above initial output voltage. This voltage was taken as the output voltage in low temperature environment after storage at high temperature. The output voltage of each power storage device was expressed as a relative value, with the initial output voltage of the power storage device of Comparative Example 1 taken as 100.

The results are shown in Table 1. In Table 1, A1 to A8 are batteries of Examples 1 to 8, and B1 to B3 are batteries of Comparative Examples 1 to 3.

TABLE 1

| | IPDI component | | output voltage (relative value) | |
|---|---|---|---|---|
| | cis/trans | concentration | | after storage at |
| | ratio | (mass %) | initial | high temperature |
| A1 | 78/22 | 3 | 116 | 103 |
| A2 | 83/17 | 3 | 128 | 109 |
| A3 | 95/5 | 3 | 121 | 105 |
| A4 | 39/61 | 3 | 110 | 98 |
| A5 | 39/61 | 0.2 | 107 | 95 |
| A6 | 68/32 | 3 | 117 | 101 |
| A7 | 68/32 | 10 | 128 | 108 |
| A8 | 68/32 | 15 | 115 | 90 |
| B1 | — | 0 | 100 | 78 |
| B2 | 23/77 | 3 | 97 | 59 |
| B3 | 98/2 | 3 | 102 | 71 |

Table 1 shows that, in the IPDI component, when the cis/trans ratio of the IPDI compound was less than 35/65, as compared to when the nonaqueous liquid electrolyte contained no IPDI compound, the initial output voltage in low temperature environment dropped (comparison between B1 and B2). The drop in output voltage was even more noticeable after storage at high temperature (comparison between B1 and B2). When the cis/trans ratio of the IPDI compound was more than 96/4, the output voltage improvement effect by using the IPDI component was barely obtained, and the output voltage further dropped after storage at high temperature (comparison between B1 and B3).

On the other hand, when the cis/trans ratio was 35/65 or more, the initial output voltage was improved by 13% as compared to when less than 35/65, and by 10% as compared to when no IPDI component was used (comparison of A4 with B1 and B2). The difference in output voltage becomes even more noticeable after storage at high temperature. When the cis/trans ratio was 35/65 or more, the output voltage after storage at high temperature was improved by 39% as compared to when less than 35/65, and by 20% as compared to when no IPDI component was used (comparison of A4 with B1 and B2). Furthermore, when the cis/trans was 96/4 or less, the initial output voltage was improved by 19% as compared to when more than 96/4, and by 21% as compared to when no IPDI component was used (comparison of A3 with B1 and B3). The difference in output voltage becomes even more noticeable after storage at high temperature. When the cis/trans ratio was 96/4 or less, the output voltage after storage at high temperature was improved by 34% as compared to when more than 96/4, and by 27% when no IPDI component was used (comparison of A3 with B1 and B3). As shown above, by using the IPDI compound having a cis/trans ratio of 35/65 or more and 96/4 or less, it is possible to significantly improve the output voltage in low temperature environment, and to considerably suppress the drop in output voltage after storage at high temperature.

From the viewpoint of ensuring higher output voltage in low temperature environment, the cis/trans ratio in the initial nonaqueous liquid electrolyte is preferably 60/40 or more. From the similar point of view, the concentration of the IPDI component in the initial nonaqueous liquid electrolyte is preferably 12% or less or 10% or less.

Although, in the Examples, examples in which lithium primary batteries are used as the power storage device are shown, other power storage devices (e.g. lithium-ion secondary batteries, lithium secondary batteries, lithium-ion capacitors) can be used with the same as or similar effects to the above.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The nonaqueous liquid electrolyte of the present disclosure is useful as a nonaqueous liquid electrolyte for a power storage device. The power storage device using the nonaqueous liquid electrolyte of the present disclosure is suitably applicable, for example, as a main power source for various meters or a memory backup power source. Examples of the power storage device include lithium primary batteries, lithium-ion secondary batteries, lithium secondary batteries, and lithium-ion capacitors. The application of the nonaqueous liquid electrolyte and the power storage device, however, are not limited thereto.

### REFERENCE SIGNS LIST

1 positive electrode
1a positive electrode current collector
2 negative electrode
3 separator
4 positive electrode lead
5 negative electrode lead
6 upper insulating plate
7 lower insulating plate
8 sealing plate
9 battery case
10 power storage device

1. A nonaqueous liquid electrolyte for use in a power storage device, comprising:
a solute;
a nonaqueous solvent; and
an isophorone diisocyanate component, wherein
the isophorone diisocyanate component includes a cis-isophorone diisocyanate compound and a trans-isophorone diisocyanate compound, and
a mass ratio cis/trans of the cis-isophorone diisocyanate compound to the trans-isophorone diisocyanate compound is 35/65 or more and 96/4 or less.

2. The nonaqueous liquid electrolyte according to claim 1, wherein a concentration of the isophorone diisocyanate component is 15 mass % or less.

3. The nonaqueous liquid electrolyte according to claim 1, wherein the solute includes a lithium salt.

4. The nonaqueous liquid electrolyte according to claim 1, wherein
the power storage device is a lithium primary battery including a pair of electrodes,
one of the pair of electrodes includes at least one of metal lithium and a lithium alloy, and
the other electrode includes a positive electrode mixture containing manganese dioxide.

5. A power storage device, comprising:
a pair of electrodes; and a nonaqueous liquid electrolyte, wherein
the nonaqueous liquid electrolyte includes
a solute,
a nonaqueous solvent, and
an isophorone diisocyanate component,
the isophorone diisocyanate component includes a cis-isophorone diisocyanate compound and a trans-isophorone diisocyanate compound, and
a mass ratio cis/trans of the cis-isophorone diisocyanate compound to the trans-isophorone diisocyanate compound is 35/65 or more and 96/4 or less.

6. The power storage device according to claim 5, wherein
one of the pair of electrodes is capable of electrochemically dissolving or releasing lithium ions, and the other electrode is capable of electrochemically depositing or absorbing lithium ions, and
the nonaqueous liquid electrolyte includes a lithium salt.

7. The power storage device according to claim 6, wherein
the one electrode contains at least one selected from the group consisting of lithium element, silicon element, and a carbonaceous material, and
the other electrode contains at least one element selected from the group consisting of manganese, nickel, and cobalt.

8. The power storage device according to claim 6, wherein
the power storage device is a lithium primary battery,
the one electrode includes at least one of metal lithium and a lithium alloy, and
the other electrode includes a positive electrode mixture containing manganese dioxide.
